(19) United States
(12) Patent Application Publication
(10) Pub. No.: US 2009/0308684 A1
(43) Pub. Date: Dec. 17, 2009

(54) ECHOLOCATION DEVICE

(76) Inventor: Martin L. Lenhardt, Hayes, VA (US)

Correspondence Address: Hershkovitz & Associates, LLC, 2845 Duke Street, Alexandria, VA, 22314, US

(21) Appl. No.: 12/522,159

(22) PCT Filed: Jan. 4, 2008
(86) PCT No.: PCT/US2008/050232

§ 371 Date: Jul. 3, 2009

Related U.S. Application Data
(60) Provisional application No. 60/878,363, filed on Jan. 4, 2007.
(60) Provisional application No. 60/878,367, filed on Jan. 4, 2007.

(51) Int. Cl. G01S 15/00

(52) U.S. Cl. 181/123

(57) ABSTRACT

A device and method of using the device for the detection of objects within structures or environments of interest is disclosed which utilizes ultrasonic signals and echoes for said detection.

### CROSS-REFERENCE TO RELATED APPLICATIONS

This application claims the benefit of provisional patent application No. 60/878,367 entitled “Underwater Ship Compartment Inspection Device” filed Jan. 4, 2007, the entirety of which is incorporated by reference. This application also claims the benefit of provisional patent application No. 60/878,363 entitled “Echolocator For Spatial Hearing Orientation And Learning” filed Jan. 4, 2007, the entirety of which is incorporated by reference.

### FIELD OF INVENTION

This invention relates generally to a device and method of using said device for the detection of objects in both aqueous and non-aqueous environments.

### BACKGROUND OF THE INVENTION

Ultrasound has the potential to allow persons to “see” what cannot be seen. For example, narcotics and other contraband are often smuggled into countries hidden in a transport structure. In particular, smugglers may use fuel or water tanks, or create or use cavities in walls or in and around bulkheads. Because of the need to detect contraband and because many smuggling operations utilize aquatic vehicles such as boats and cargo barges, there is a present need for a device which will improve the efficiency and success rate of detection. Previous methods for detecting contraband require, for example, cutting openings into the structure under investigation. This is time-consuming, expensive, and may cause structural damage, particularly to vessels. As such, there is a present need for a device and method of using such a device for the detection of objects, such as contraband, in containers, walls, or other structures. The ability to “see” what cannot be seen also has the potential to address therapeutic needs. For example, infants born blind or blind and deaf have been shown to mature in their faculties at a slower rate. In part, development of mental and physical faculties requires external stimulus. It has been shown that children exposed to enriched environments develop mental and physical faculties at a faster rate. Unfortunately, infants born blind or blind and deaf have lost a critical means for external stimulus. As such, there is a present need for a device and method of using such a device for providing alternate means for stimulation of an infant's mental and physical faculties.

### SUMMARY OF THE INVENTION

The present invention, in one or more embodiments, is a device for the detection of objects in a structure or environment comprising a signal source which provides a raw signal; a first signal processor adapted to process said signal source, thereby producing a processed signal; a first amplifier adapted to amplify the processed signal source, thereby producing a processed, amplified signal; a first emitter adapted to emit either the raw signal, the processed signal or the processed, amplified signal, said emitter adapted to emit through the use of a first emitter transducer; a signal sensor adapted to receive the echoes of either the raw signal, the processed signal or the processed, amplified signal source; a second signal processor adapted to process the echoes of either the raw signal, the processed signal or the processed, amplified signal, thereby producing a processed echo signal; a second amplifier adapted to amplify the processed echo signal, thereby producing a processed, amplified echo signal; and a second emitter, adapted to emit a signal through a second transducer, said second transducer adapted to provide either a vibratory signal or an acoustic signal, said second transducer further adapted to provide an ultrasonic signal and also optionally further adapted to provide an ultrasonic signal via bone conduction.

The present invention may also be, in one or more embodiments, a method of using the device of this invention comprising the steps of providing the invention device to a user and allowing the user to optionally place the device on a helmet or other carrying device disposed on said user; optionally allowing the user to activate the signal source, thereby causing the first emitter to emit the raw signal, the processed signal source, or the processed, amplified signal source; optionally allowing the user to modify the processing and/or the amplification of the signal source to enhance discrimination and detection of objects in a structure; activating the signal source if not already activated; adjusting the processing and/or amplification of the signal source, in real-time, to enhance discrimination and detection of objects in a structure of interest; pointing the first emitter towards said structure of interest, thereby producing an echo; allowing said first emitter to emit via the first transducer; listening via the second transducer for said echo; pointing the first emitter at various points on the structure of interest; listening to changes via the second transducer in said echo's acoustic characteristics; optionally adjusting the echo's acoustic characteristics via the second processor and/or second amplifier; and continuing until the structure of interest has been scanned.

In a user-friendly application, the above devices and methods may be adapted for placement on an infant's head, thereby providing feedback, i.e. sensory stimulation, to infant's who are born blind. In an alternate embodiment, the device may be supplemented with tactile or vibratory transducers for use with infants who are deaf and blind.

The present invention thereby achieves, in one or more embodiments, at least one or more of the following objectives and others that are apparent upon reading of the specification and claims:
1. Targets with air boundaries can be readily detected;
2. Targets can be detected within tanks and fluid filled pipes;
3. Targets can be detected despite the presence of baffles between the target and the ultrasound source;
4. False walls, concealing air spaces, can be detected;
5. False walls, containing baffles, can be detected;
6. Rounded tank corners offer no impediment to target detection;
7. Targets can be readily detected by infants with sensory impairment;
8. Infants with sensory impairment can be provided with sensory data to stimulate the development of their mental and physical faculties;
9. Signal strength is within safety limits for stimulation of an infant's cranium; and
10. Sensory data provided to infants is above the normal speech sound frequency, thereby not interfering with normal infant speech development.

### BRIEF DESCRIPTION OF THE DRAWINGS

The present invention can best be understood in connection with the accompanying drawings. It is noted that the invention is not limited to the precise embodiments shown in drawings, in which:

FIG. 1 is a diagrammatic representation of one embodiment of the present invention;

FIG. 2 is a schematic representation showing the interconnection of various elements of the device.

FIG. 3 is a schematic of one feature of an embodiment of the invention in which reflected echoes provide the brain with information for spatial localization of the signal.

FIG. 4 is a perspective view of the piezoelectric ceramic rod array in a polymer matrix.

### BRIEF DESCRIPTION OF REFERENCE NUMERALS

100 Signal Source Generator; 102 Signal Processor; 104 Signal Amplifier; 106 Signal Emitter; 108 Tank or Other Structure to be Analyzed; 110 Signal (Echo) Sensor/Receiver; 112 Signal Processor; 114 Signal Amplifier; 116 Transducers/Human; 118 Power Pack; 120 Signal Processor/Amplifier/Receiver and Emitter; 122 Signal in; 124 Signal Out; 126 Left Ear; 128 Right Ear; 130 Transducer Adjustment (Vertical); 132 Transducer Adjustment (Rotational); 200 Human Head; 202 Pulse Stimulus Generator; 300 Polymer Matrix; and 302 Piezoelectric Ceramic Rod.

### DETAILED DESCRIPTION OF THE INVENTION

In one embodiment of the present invention, a hand-held, man-portable device provides information on material hidden from vision within fuel or water tanks, or behind bulkheads or walls. The device functions by utilizing an improved ultrasonic probe that uses the innate capabilities of human hearing to provide discrimination of targets that cannot be obtained using time-delay algorithms and digital readouts.

Existing inspection devices use various forms of energy that can penetrate the walls of tanks or compartments and provide information that reflects the contents of the scanned object. These devices include fluoroscopic screening devices, ION SCAN equipment, and an early version ultrasonic device. These devices were unsuccessful in providing the requisite sensitivity, practicality, and utility for detecting contraband in objects. The innovation in the invention is the use of a machine-man interface and the use of the human nervous system in the detection task.

It is understood in the art that low frequency ultrasound (<40 kHz) has a relatively long wavelength in regard to frequencies on the order of MHz. These “low” ultrasonic frequencies are ideal for scanning fluid filled containers and assessing content homogeneity. The invention, in one embodiment, relies on the presence of air in water-filled containers. Contraband is often wrapped in waterproofing materials to prevent the contraband from becoming damaged. This waterproofing process inevitably causes air to be retained inside the contraband package.

When a pulsed, amplitude modulated (AM) beam is directed towards a material containing air, the air is scattered in a manner resulting in a change in echo patterns returning back to the receiver. The resulting change in echo intensity and form is perceived as a change in loudness and, to some extent, as a change in pitch by the human auditory system. The resulting detection threshold, i.e. the sensitivity of the device, is quite high in that detection of contraband is quite robust.

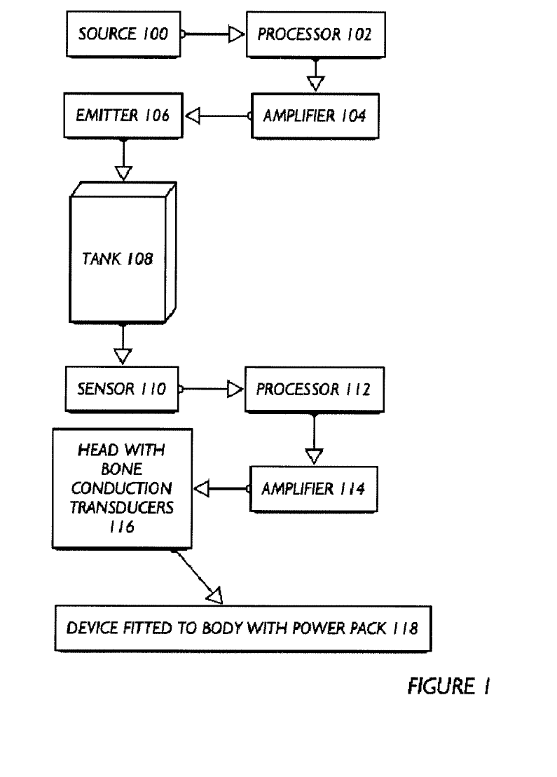

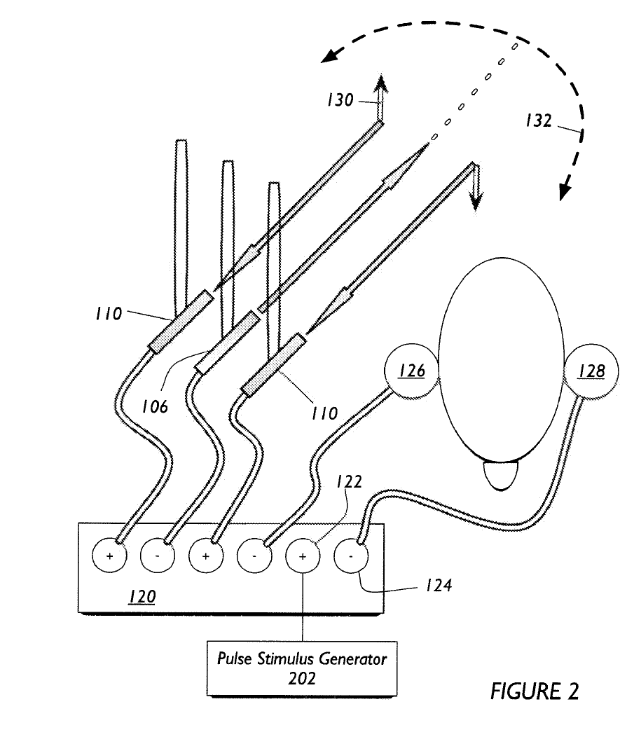

The invention, in a preferred embodiment, comprises a source signal generator (represented as 100 in FIG. 1 and also 202 in FIG. 2), such as digital oscillator, providing a preferred frequency of 23 kHz. Frequencies about this range, such as from 18 to 28 kHz may also be appropriate. The invention further comprises a processor 102 capable of performing a Fourier analysis of a variety of outgoing emitter signals. The outgoing emitter signals may be modified in type to improve discrimination within the tank environment. Certain basic signal types are preferred, although others are contemplated, and include 1) Pure tones (Continuous Waves (CW)); 2) Noise (CW); 3) Amplitude modulated (AM) noise (CW); AM pulsed noise, Frequency modulated (FM) noise, and FM pulsed noise. Of the above, the most preferred is use of AM ultrasonic (23 kHz carrier) noise pulse. Signals may be modified in real-time. Such “real-time” signal modification can comprise the steps of emitting a signal, listening to the return signal, and adjusting the processing/amplification of either the emitted or received signal while scanning the object.

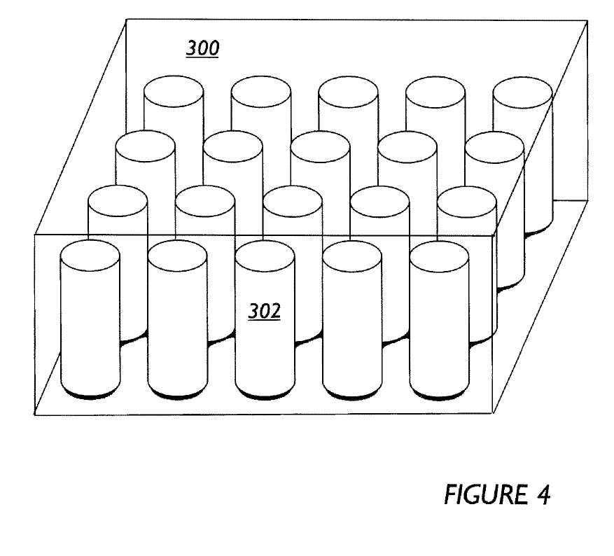

The invention additionally comprises an amplifier 104 that provides power to the emitter and can vary the intensity according to the fluid volume to be probed, i.e. higher volume requires higher intensity. Further, the invention comprises an emitter 106. In a preferred embodiment, the emitter comprises piezoelectric ceramic rods (302 in FIG. 4) embedded in a polymer matrix (300 in FIG. 4) with a wide frequency response and sensitivity. Such an emitter is preferred for underwater uses, but other transducers may be used, particularly in non-aqueous environments. In such an embodiment, the device (while using broadband noise (1 Hz-100 kHz)) can display a frequency response from about 10 Hz to over 50 kHz. A practitioner can assess the frequency response by direct coupling of the emitter to the receiver using a real-time analyzer and by the use of a high-frequency accelerometer. The low frequency sensitivity is an advantage of this embodiment of the present invention in that it allows transducers to code both bulk water movement plus target identification information simultaneously. This provides a valuable advantage in that contraband that is only tethered within the container can be identified. The transducers (and other parts of the device) may be waterproofed and can be incorporated into a PVC pipe (which can act as a wave-guide). Such transducers are effective in water-filled guides, and small and large tanks but may also be used in non-water environments.

According to the present invention, the presence of baffles and crossing pipes does not inhibit the target identification by direct ultrasonic listening. In a preferred embodiment, a three-transducer (one emitter 106 and two receiver 110) arrangement is utilized to stimulate each ear (126 and 128) in order to the auditory system's localization neurons to compute the target source. The auditory system has both ipsilateral and contrallateral pathways that provide the necessary interactions that form the structural basis of sound localization in air or liquid.

The present invention further comprises a sensor 110. In one embodiment, the emitter/sensor transducers may be in one transducer, i.e. the transducer can function to both receive and emit a signal. The present invention also comprises a processor 112 for echo conditioning and amplitude compression (or expansion) and also an amplifier 114 to provide sufficient gain for comfortable human listening of the signal. Finally, bone conduction ultrasonic transducers 116 or tactile vibrators may be used to allow normal or covert listening at high frequencies or through the use of vibration. See the related applications, herein incorporated by reference, to the present inventor, filed as a provisional application No. 60/878,339 entitled “Ultrasonic Acoustic Warning Device” on Jan. 4, 2007, and the related non-provisional of the same name and inventorship, filed Jan. 4, 2008.

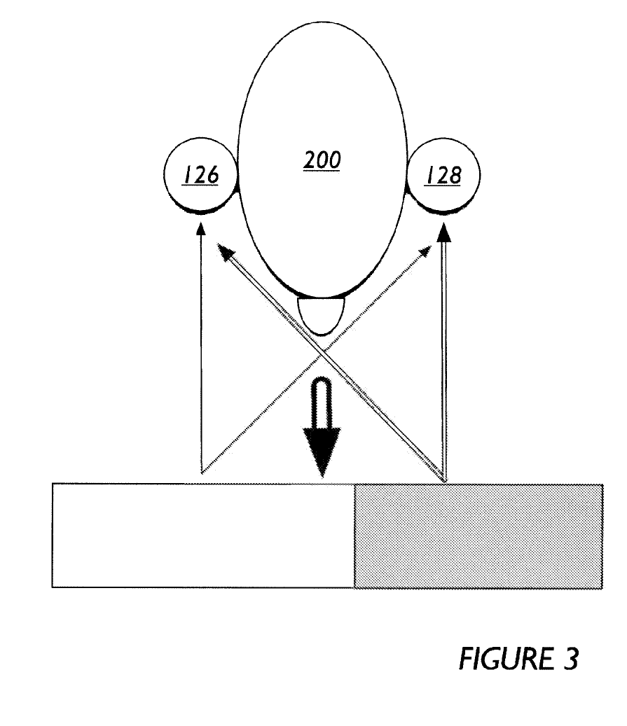

The entire device assembly may be fitted to a human body along with a power pack such as a battery, thereby allowing the device to be mobile. In fitting the device to the human body, the transducers may be arranged unto a helmet in a such a manner that one echo signal emitter is located near one ear 130 and another echo signal emitter is located near the other ear 132 on a human 200 as in FIGS. 2 and 3. FIG. 3 shows the advantage of such an arrangement. While scanning an object that contains contraband, the change in homogeneity of the object will result in a change in echo signal. The displacement of the returning signals, in a manner like human stereovision, provides spatial localization information to the human brain that processes the information and provides additional, useful information about the location of the inhomogeneity.

In operation, an ultrasonic beam is emitted into a tank. If the medium is homogeneous and all objects have the same acoustic impedance, few echoes will be reflected. Thus, fluid, baffles, fluid filled pipes and guides will reflect few echoes; however, anything with even a small amount of enclosed air will scatter an ultrasonic beam such that the intensity of the returning echoes will be lower. The sensors of the device will receive those echoes, condition them, and deliver them to the head as a vibration, sonic, or ultrasonic signal. During the process of listening (sonic, vibratory, ultrasonic, or otherwise), if the inspection beam hits a reflecting target, the user will be able to detect the object by noticing a robust drop in echo loudness and a change in the timbre or pitch of the signal. The ear receiving the strongest echo codes the target source.

In an alternate but related embodiment, the above device may be slightly modified to provide a means for treating infants born deaf and deaf/blind. The echolocation device may be adapted for placement onto an infant's cranium. As the infant scans a room, the echolocator will receive signals (echoes) from those emitted by the transducers. Since the received signals are presented to the infant at an ultrasonic pitch (and subsequently demodulated by the natural resonance of the baby, in particular, the baby's cranium), the child is able to perceive a signal that provides location data on objects in the environment, such as a toy.

Because the signal is presented above the normal speech perception range, normal speech perception is not affected. Further, if the child is deaf, tactile vibrators may be substituted for the ultrasonic transducers. Such a device can be effectively used to enhance (enrich) an infant's environment, thereby aiding in its normal growth and development. A person of skill in the art will recognize that the above underwater inspection device has numerous applications, both above and below water, as demonstrated by the infant echolocation device. Note, since the detection of objects need not be as robust as in the above underwater inspection embodiment, the frequency output and/or modulation need not be as refined, although ultrasonic signals are highly preferred. Also note, it is preferred that the beam-width of the emitters be narrower than that used for underwater inspection, since a narrow-beam width promotes head-turning (locating behavior) in infants.

In an additional embodiment, the infant device can be modified for use by military personnel. Instead of a narrow beam, a wider beam maybe used to help with, e.g., location of enemy personnel in smoke. In general, the closer an object, the lower the pitch, although this can be changed.

It is to be noted that in any embodiment of the device, multiple channels for the various signals may be used or various signals may be sent on a single or on multiple carrier waves. There may be more than one raw signal source generator and any reference to the signal source is understood to comprise a single source or multiple source generators. Further, any signal processors referred to are to be understood as comprising either a single processor or multiple processors. Similarly, any reference to an amplifier is to be understood as a reference to a single or to multiple amplifiers. The amplifiers and processors may operate to individually amplify and/or process various parts of the frequency spectrum or the spectrum as a whole. Any reference to a transducer is also to be understood as a reference to one or more transducers. Such transducers may be adapted to emit and/or receive in specified regions of the electromagnetic spectrum, i.e. they may emit at various frequencies. While low ultrasound frequencies are preferred, other frequencies may also be emitted which aid in the detection and/or discrimination of objects in structures of interest. Finally, multiple devices for the detection of objects in a structure may be used and the method of using such a device contemplates using several devices orjust one for the detection of objects of interest.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention. It is further known that other modifications may be made to the present invention, without departing the scope of the invention, as noted in the appended claims.

I claim:

1. A device for the detection of objects in a structure or environment comprising:
a) a signal source which provides a raw signal;
b) a first signal processor adapted to process said raw signal in which said processing includes filtration, thereby producing a processed signal;
c) a first amplifier adapted to amplify the processed signal, thereby producing a processed, amplified signal;
d) a first emitter adapted to emit either the raw signal, the processed signal or the processed, amplified signal, said emitter adapted to emit through the use of a first emitter transducer;
e) a signal sensor adapted to receive the echoes of either the raw signal, the processed signal or the processed, amplified signal source;
f) a second signal processor adapted to process the echoes of either the raw signal, the processed signal or the processed, amplified signal, thereby producing a processed echo signal in which said processing includes filtration;
g) a second amplifier adapted to amplify the processed echo signal, thereby producing a processed, amplified echo signal; and
h) a second emitter, adapted to emit a signal through a second transducer, said second transducer adapted to provide either a vibratory signal or an acoustic signal, said second transducer further adapted to provide an ultrasonic signal and also optionally further adapted to provide an ultrasonic signal via bone conduction.

2. The device of claim 1 further comprising a power pack thereby adapting the device for portable use.

3. The device of claim 1 in which said raw signal, said processed signal, and/or said processed, amplified signal are in the low ultrasound frequencies.

4. The device of claim 3 in which said low ultrasound frequencies are below 40 kilohertz (kHz).

5. The device of claim 1 in which said signal source provides a raw signal at a frequency of between 18 and 28 kilohertz (kHz), or said first amplifier or said first processor provides a amplified, processed, or amplified and processed signal at a frequency of between 18 and 28 kilohertz (kHz).

6. The device of claim 5 in which the provided signal has a frequency of around 23 kilohertz (kHz).

7. The device of claim 1 in which said device displays a frequency response of about 10 Hertz (Hz) to at least about 50 kilohertz (kHz).

8. The device of claim 1 in which said device is waterproofed for use in aqueous or liquid environments.

9. The device of claim 1 in which said device is adapted for placement on an infant's head.

10. The device of claim 1 in which said device is adapted for use by an infant.

11. A method of using the device of claim 1 comprising the steps of
a) providing the device of claim 1 to a user and allowing the user to optionally place the device on a helmet or other carrying device disposed on said user;
b) optionally allowing the user to activate the signal source, thereby causing the first emitter to emit the raw signal, the processed signal source, or the processed, amplified signal source.
c) optionally allowing the user to modify the processing and/or the amplification of the signal source to enhance discrimination and detection of objects in a structure.
d) activating the signal source if not already activated;
e) adjusting the processing and/or amplification of the signal source, in real-time, to enhance discrimination and detection of objects in a structure of interest;
f) pointing the first emitter towards said structure of interest, thereby producing an echo;
g) allowing said first emitter to emit via the first transducer;
h) listening via the second transducer for said echo;
i) pointing the first emitter at various points on the structure of interest;
j) listening to changes via the second transducer in said echo's acoustic characteristics.
k) optionally adjusting the echo's acoustic characteristics via the second processor and/or second amplifier; and
l) continuing steps i) through k) until the structure of interest has been scanned.

12. The method of claim 1 in which said echo's acoustic characteristics include spatial localization information.

13. The method of claim 8 in which said second transducer utilizes bone conduction.

14. A method for the detection of objects in a structure comprising:
a) processing a raw signal to produce a processed signal;
b) amplifying the processed signal to produce an amplified, processed signal and emitting either the raw signal, the processed signal or the processed, amplified signal, said emitter adapted to emit through the use of a emitter transducer; and
c) receiving echoes and processing and/or amplifying the echoes that are then relayed to a user.

15. The method of claim 14, further comprising the steps of
a) pointing said emitter towards said structure of interest, thereby producing an echo from the structure of interest;
b) listening for said echo from the structure of interest;
c) pointing said emitter at various points on the structure of interest;
d) listening to changes in the acoustic characteristics of said echo from the structure of interest; and
e) continuing steps a) through d) until the structure of interest has been scanned.

16. A method of treating hearing or vision loss in an infant using the device of claim 1.
